(19) United States
(12) Patent Application Publication
(10) Pub. No.: US 2018/0283880 A1
(43) Pub. Date: Oct. 4, 2018

(54) INFRASTRUCTURE TO VEHICLE POSITION VERIFICATION

(71) Applicant: GM GLOBAL TECHNOLOGY OPERATIONS LLC, Detroit, MI (US)

(72) Inventors: STEVEN R. CROYLE, BRINGHAM FARMS, MI (US); ERAY YASAN, CANTON, MI (US); MICHAEL KLEBBA, BRUCE TOWNSHIP, MI (US)

(73) Assignee: GM GLOBAL TECHNOLOGY OPERATIONS LLC, Detroit, MI (US)

(21) Appl. No.: 15/478,136

(22) Filed: Apr. 3, 2017

(51) Int. Cl. G01C 21/28; H04W 4/04

(52) U.S. Cl. CPC G01C 21/28; H04W 4/008; H04W 4/046

(57) ABSTRACT

Methods and systems are provided for determining a position of a vehicle. In one example, the vehicle includes one or more wheels; a drive system configured to power the one or more wheels; a receiver installed onboard the vehicle, the receiver configured to receive location information from a infrastructure element in proximity to the vehicle; and a processor installed onboard the vehicle, the processor configured to determine a position of the vehicle using the location information from the infrastructure element.

### TECHNICAL FIELD

The technical field generally relates to the field of vehicles and, more specifically, to methods and systems for utilizing infrastructure to vehicle communications to verify a position of the vehicle.

### BACKGROUND

Today's vehicles often utilize techniques for ascertaining a position of the vehicle, for example using global navigation satellite systems (GNSS) and/or dead reckoning techniques. However, existing techniques may not always provide optimal position results, for example when the vehicle is in a location in which GNSS signals are blocked and/or in which calibration of dead reckoning sensors may be difficult (e.g., in a tunnel, a parking garage, and so on).

Accordingly, it is desirable to provide improved methods and systems for ascertaining a position of a vehicle. Furthermore, other desirable features and characteristics of the present invention will become apparent from the subsequent detailed description of the invention and the appended claims, taken in conjunction with the accompanying drawings and this background of the invention.

### SUMMARY

In accordance with an exemplary embodiment, a method is provided. The method includes obtaining, via a receiver onboard a vehicle, location information from a infrastructure element in proximity to the vehicle; and determining, via a processor onboard the vehicle, a position of the vehicle using the location information from the infrastructure element.

In accordance with another exemplary embodiment, a system is provided. The system includes a receiver and a processor. The receiver is configured to be installed onboard a vehicle, and to receive location information from a infrastructure element in proximity to the vehicle. The processor is configured to be installed onboard the vehicle, and to determine a position of the vehicle using the location information from the infrastructure element.

In accordance with a further exemplary embodiment, a vehicle is provided. The vehicle includes one or more wheels; a drive system configured to power the one or more wheels; a receiver installed onboard the vehicle, the receiver configured to receive location information from a infrastructure element in proximity to the vehicle; and a processor installed onboard the vehicle, the processor configured to determine a position of the vehicle using the location information from the infrastructure element.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle depicted alongside an infrastructure element in proximity to the vehicle, the vehicle including a position system for ascertaining a position of the vehicle using information obtained from the infrastructure element, in accordance with an exemplary embodiment;

FIG. 2 is a flowchart of a process for ascertaining a location of a vehicle using information obtained form an infrastructure element, and that can be implemented in connection with the vehicle, the position system, and the infrastructure element of FIG. 1, in accordance with an exemplary embodiment;

FIG. 3 provides an illustration of an exemplary implementation of the process of FIG. 2, using a first infrastructure element comprising a tunnel, in accordance with an exemplary embodiment; and

FIG. 4 provides an illustration of an exemplary implementation of the process of FIG. 2, using a second infrastructure element comprising a building parking garage, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

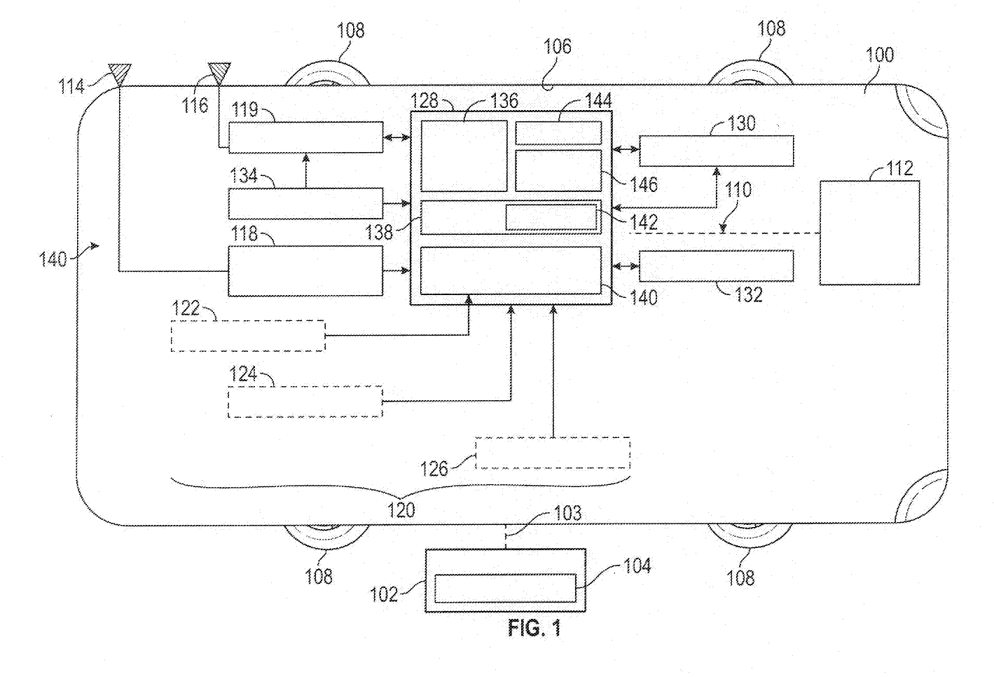

FIG. 1 illustrates a vehicle 100, according to an exemplary embodiment. The vehicle is illustrated along with an infrastructure element 102 that is disposed in proximity to the vehicle 100. The infrastructure element 102 includes a transmitter 104 that provides information to the vehicle 100 via one or more communication networks 103 (e.g., a short range wireless communication network, in one embodiment). In various embodiments, the infrastructure element 102 may comprise a tunnel, a bridge, a building, a parking garage, a traffic light, a stop sign, a street sign, a road divider or barrier, and/or any other number of different types of elements associated with infrastructure that may be part of, associated with, and/or surrounding vehicles, roadways, and/or locations by which vehicles travel. In various embodiments, the infrastructure element 102 transmits information to the vehicle 100 (e.g., including a position or location of the infrastructure element 102 and/or the vehicle 100, a heading of the vehicle 100 and/or information relating thereto, such as a lane, tunnel, portion, or component of the infrastructure element 102 via which the vehicle 100 is travelling, and so on) using the transmitter 104, via the communication network 103.

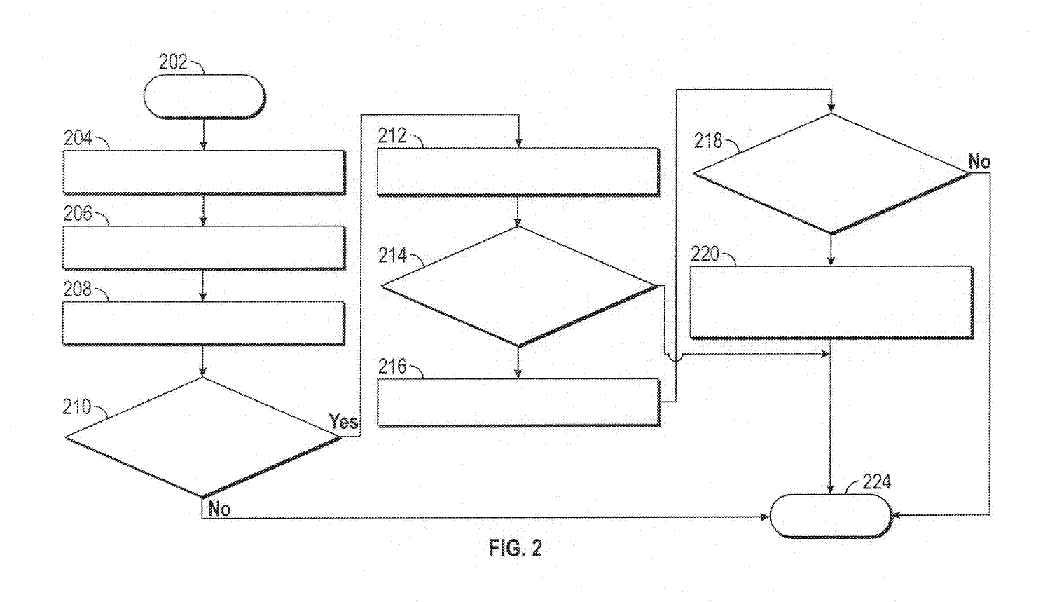

As described in greater detail further below, the vehicle 100 includes various components that assist in ascertaining a position of the vehicle 100, utilizing information provided by the infrastructure element 102, in accordance with an exemplary embodiment. Also as described further below, in certain embodiments such components may collectively comprise a position system 140 for ascertaining the position of the vehicle 100, for example as discussed further below in connection with FIG. 1 as well as FIGS. 2-4.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle.

The vehicle 100 includes a body 106 that is arranged on a chassis 110. The body 106 substantially encloses other components of the vehicle 100. The body 106 and the chassis 110 may jointly form a frame. The vehicle 100 also includes a plurality of wheels 108. The wheels 108 are each rotationally coupled to the chassis 110 near a respective corner of the body 106 to facilitate movement of the vehicle 100. In one embodiment, the vehicle 100 includes four wheels 108, although this may vary in other embodiments (for example for trucks and certain other vehicles).

A drive system 112 is mounted on the chassis 110, and drives the wheels 108 (including the wheels 108). In various embodiments, the drive system 112 comprises one of a number of different types of propulsion system. In certain exemplary embodiments, the drive system 112 comprises an internal combustion engine and/or an electric motor/generator, coupled with a transmission thereof. In certain embodiments, the drive system 112 may vary, and/or two or more drive systems 112 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

As depicted in FIG. 1, in various embodiments the vehicle 100 also includes a short range antenna 114, a GNSS antenna 116, a short range receiver 118, a GNSS receiver 119, a sensor array 120, a computer system 128, a user interface 130, a mapping database 132, and a power source 134. It will be appreciated that certain of these features may vary in different embodiments. In addition, in certain embodiments, some or all of these features may be collectively referred to as being part of the position system 140 for ascertaining the position of the vehicle 100, for example as discussed further below in connection with FIG. 1 as well as FIGS. 2-4.

In various embodiments, the short range antenna 114 and the short range receiver 118 receive short range wireless communications. In various embodiments, the short range antenna 114 and the short range receiver 118 receive wireless communications (including wireless, electronic messages including information as to a position and a heading of the vehicle 100) from the infrastructure element 102 via the communication network 103. In one embodiment, the short range antenna 114 comprises a digital short range communication (DSRC) antenna, and the short range receiver 118 comprises a DSRC receiver; however, this may vary in other embodiments.

In various embodiments, the GNSS antenna 116 and the GNSS receiver 119 receive wireless communications from one or more satellite-based GNSS systems, such as a global positioning system (GPS) system and/or one or more other types of GNSS systems, for determining a position of the vehicle 100. In one embodiment, the GNSS antenna 116 comprises a GPS antenna, and the GNSS receiver 119 comprises a GPS receiver; however, this may vary in other embodiments.

As depicted in FIG. 1, in various embodiments the sensor array 120 includes one or more accelerometers 122, speed sensors 124, and heading sensors 126. The accelerometers measure an acceleration of the vehicle 100. The speed sensors 124 measure one or more speeds of the vehicle 100. In certain embodiments, the speed sensors 124 comprise wheel speed sensors that are coupled to respective wheels 108 of the vehicle 100, and measure wheel speed and/or other information that may be used in determining a speed for the vehicle 100. The heading sensors 126 measure a heading, or direction of travel, of the vehicle 100. In accordance with various embodiments, the sensors of the sensor array 120 provide this information to the computer system 128 (e.g., to the processor 136 thereof, discussed below), for processing.

The computer system 128 provides instructions and executes processes for determining a position of the vehicle 100. In various embodiments, the computer system 128 provides these functions using information provided by the short range antenna 114, the GNSS antenna, the short range receiver 118, the GNSS receiver 119, the sensor array 120, the user interface 130, and the mapping database 132. In various embodiments, the computer system 128 provides these functions in accordance with the process 200 described further below in connection with FIGS. 2-4. In various embodiments, the computer system 128 is disposed within the body 106 of the vehicle 100. In one embodiment, the computer system 128 is mounted on the chassis 110.

Also as depicted in FIG. 1, in various embodiments the computer system 128 includes a processor 136, a memory 138, and interface hardware 138. In various embodiments, the processor 136 comprises an application processor, and performs the computation and control functions of the computer system 128. In various embodiments, the processor 136 may comprise any type of processor or multiple processors, single integrated circuits such as a microprocessor, or any suitable number of integrated circuit devices and/or circuit boards working in cooperation to accomplish the functions of a processing unit. During operation, the processor 136 executes one or more programs 142 contained within the memory 138 and, as such, controls the general operation of the computer system 128 and the computer system of the computer system 128, generally in executing the processes described herein, such as the process 200 described further below in connection with FIGS. 2-5.

The memory 138 can be any type of suitable memory. For example, the memory 138 may include various types of dynamic random access memory (DRAM) such as SDRAM, the various types of static RAM (SRAM), and the various types of non-volatile memory (PROM, EPROM, and flash). In certain examples, the memory 138 is located on and/or co-located on the same computer chip as the processor 136. In the depicted embodiment, the memory 138 stores the above-referenced program 142 along with one or more stored values pertaining to possible locations of the vehicle 100.

The interfacing hardware 140 allows communication to the computer system of the computer system 128, for example from a system driver and/or another computer system, and can be implemented using any suitable method and apparatus. In one embodiment, the interfacing hardware 140 obtains the various data from the sensors of the sensor array 120 and/or the receivers 118, 119. The interfacing hardware 140 can include one or more network interfaces to communicate with other systems or components. The interfacing hardware 140 may also include one or more network interfaces to communicate with technicians, and/or one or more storage interfaces to connect to storage apparatuses, such as the storage device 146.

In certain embodiments, the computer system 128 may also include other features, such as a bus 144 and storage device 146. The bus 144 serves to transmit programs, data, status and other information or signals between the various components of the computer system of the computer system 128. The bus 144 can be any suitable physical or logical means of connecting computer systems and components. This includes, but is not limited to, direct hard-wired connections, fiber optics, infrared and wireless bus technologies.

The storage device 146 can be any suitable type of storage apparatus, including direct access storage devices such as hard disk drives, flash systems, floppy disk drives and optical disk drives. In one exemplary embodiment, the storage device 146 comprises a program product from which memory 138 can receive a program 142 that executes one or more embodiments of one or more processes of the present disclosure, such as the steps of the process 200 (and any sub-processes thereof) described further below in connection with FIGS. 2-4. In another exemplary embodiment, the program product may be directly stored in and/or otherwise accessed by the memory 138 and/or a disk (e.g., a disk), such as that referenced below. In certain embodiments, the storage may also be provided remotely, for example through cloud storage, such as via a remote telematics, assistance, and/or other service. During operation, the program 142 is stored in the memory 138 and executed by the processor 136.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 136) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the computer system 128 may also otherwise differ from the embodiment depicted in FIG. 1, for example in that the computer system of the computer system 128 may be coupled to or may otherwise utilize one or more remote computer systems and/or other control systems.

In various embodiments, the user interface 130 enables a driver, operator, or other user of the vehicle 100 to communicate with the computer system 128. In certain embodiments, the user may provide instructions or requests (e.g., pertaining to the location of the vehicle 100) to the computer system 128 via the user interface 130. Also in certain embodiments, the user interface 130 may provide information (e.g., as to the position of the vehicle 100) to the user, for example based on instructions provided by the processor 136. In various embodiments, the user interface 130 comprises one or more display screens, buttons, knobs, keyboards, microphones, speakers, smart phones, tablets, other electronic devices, and/or other devices for communicating with a user of the vehicle 100. In certain embodiments, the user interface 130 may also represent the user's personal electronic device.

In various embodiments, the mapping database 132 includes information from maps and/or other data sources pertaining to geographic areas in which the vehicle 100 may travel, including roadways, infrastructure elements pertaining thereto, and the like. In certain embodiments, the mapping database 132 may be part of the computer system 128 (e.g., as part of the memory 138) and/or may be coupled thereto.

In various embodiments, the power source 134 provides power for one or more components of the vehicle 100, and/or for the position system 140. In the depicted embodiment, the power source 134 provides power for the GNSS receiver 118 and the computer system 128.

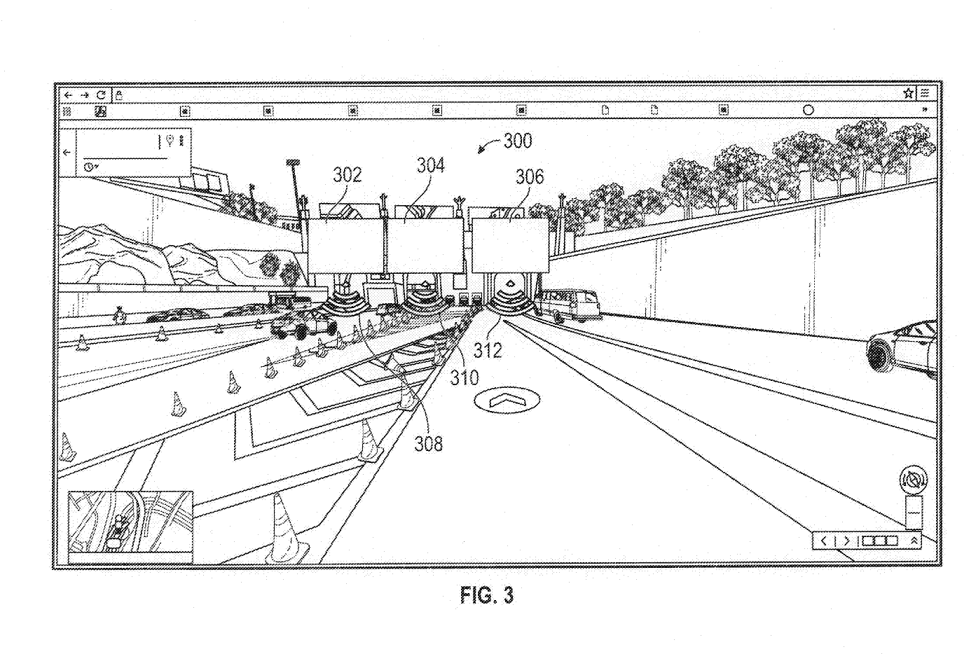

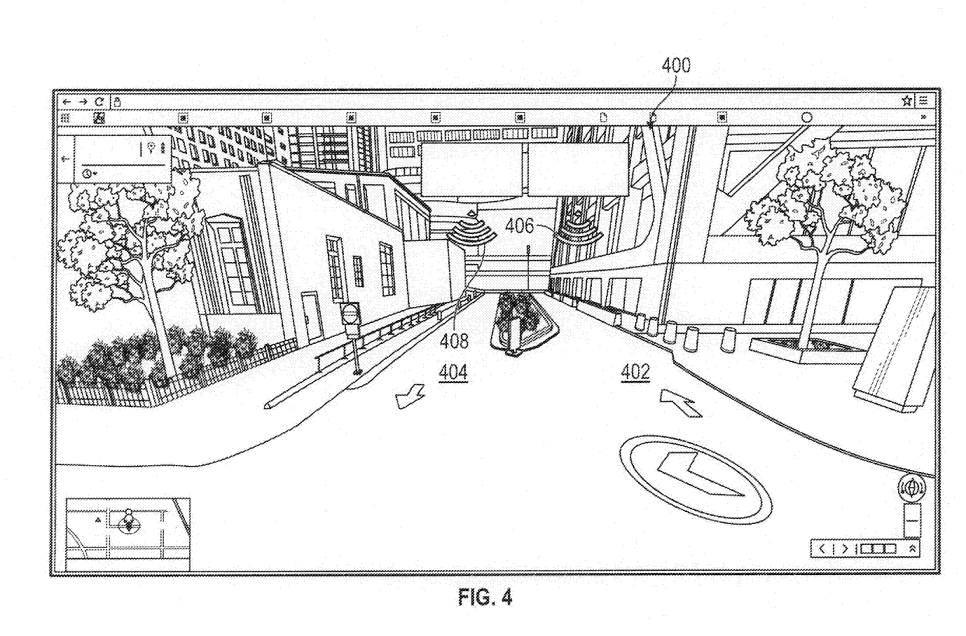

FIG. 2 is a flowchart of a process 200 for determining a position of a vehicle. The process 200 can be implemented in connection with the vehicle 100, the position system 140 and components thereof, and the infrastructure element 102 of FIG. 1, in accordance with an exemplary embodiment. In one embodiment, the process 200 begins when a vehicle drive or ignition cycle begins (for example when a driver approaches or enters the vehicle, or when the driver turns on the vehicle and/or an ignition therefor, e.g., by turning a key, engaging a keyfob or start button, and so on), and continues throughout the duration of the vehicle drive or ignition cycle. The process 200 is also discussed below in connection with FIGS. 3 and 4, which provide illustrations of exemplary infrastructure elements that can be utilized in connection with the process 200.

As depicted in FIG. 2, in one embodiment, vehicle data is obtained at step 202. In various embodiments, vehicle data is pertained to various parameters pertaining to operation of the vehicle 100, including wheel speed and vehicle speed (e.g., as obtained via the speed sensors 124 of FIG. 1), vehicle acceleration (e.g., as obtained via the accelerometers 122 of FIG. 1), a first value of a position of the vehicle 100 (e.g., as obtained via the GNSS antenna 116 and the GNSS receiver 119 of FIG. 1), and a heading of the vehicle 100 (e.g., as obtained via the heading sensor 126 of FIG. 1). In certain embodiments, the vehicle data is obtained via a message along a communication link, such as the communication link 109 of FIG. 1, and/or via a CAN bus. In certain other embodiments, the vehicle data may be obtained via one or more other manners, such as a wireless connection.

A first position value and a first heading value for the vehicle are calculated at step 206. In one embodiment, position data from the GNSS antenna 116 and the GNSS receiver 119 of FIG. 1 are utilized by the processor 136 of FIG. 1 to calculate a first position value and a first heading value as to a position and heading (e.g., the present geographic location and direction of travel of) the vehicle 100. In certain other embodiments, the first position value and the first heading value may be determined by a satellite-based navigation itself and received at the vehicle 100 via the GNSS antenna 116 and the GNSS receiver 119, along with dead-reckoning techniques, for example using the vehicle data of step 204 and the mapping database 132 of FIG. 1. In various embodiments, the first position value and the first heading value comprise values as to a three dimensional position, or current geographical location, and direction of travel with respect to the three dimensional position, respectively, of the vehicle 100.

Communications are received at the vehicle 100 from one or more infrastructure elements at step 208. In various embodiments, electronic messages are received, via the short range antenna 114 and the short range receiver 118 of FIG. 1, from the transmitter 104 of the infrastructure element 102 of FIG. 1, via the wireless communication network 103 of FIG. 1. In addition, in various embodiments, the electronic messages include information as to a current position (e.g., geographic location) of the vehicle 100 as well as a current heading (e.g., direction of travel) of the vehicle 100 as the vehicle 100 is travelling within, or in proximity to, the infrastructure element 102. Also in certain embodiments, additional parameters may also be included in the electronic messages, such as a precise location in the infrastructure element 102 (e.g., bridge, tunnel, and so on) in which the vehicle 100 is travelling, and the like. In various embodiments, the current position and current heading as received from the electronic message from the infrastructure element 102 comprise values as to a three dimensional position, or current geographical location, and a heading, or direction of travel, with respect thereto, of the vehicle 100. Also in certain embodiments, the information is analyzed by the processor 136 of FIG. 1 with respect to information from the mapping database 132 of FIG. 1.

A determination is made at step 210 as to whether the current position received at 208 is different from the calculated first position value of 206. In one embodiment, this determination is made by the processor 136 of FIG. 1. In certain embodiments, this determination may comprise whether a difference between the received current position of 208 and the calculated first position value of 206 is greater than a predetermined threshold. In one embodiment, the predetermined threshold is equal to 1.5 meters; however, this may vary in other embodiments.

If it is determined that the current position received at step 208 is not different from the calculated first position value of step 206, then in one embodiment the process 200 terminates at step 224. In one embodiment, as the process 200 terminates, the vehicle 100 continues to use the first position value from step 206 (and, in certain embodiments, as further updated using dead-reckoning techniques, for example using the vehicle data of step 204 and the mapping database 132 of FIG. 1) for continued operation of the vehicle 100.

Conversely, if it is determined that the current position received at step 208 is different from the calculated first position value of step 206, then in one embodiment at step 212 the vehicle position is set equal to the received current position value of step 208. In one embodiment, this is performed via the processor 136 of FIG. 1, and the received current position value is stored in the memory 138 of FIG. 1. In certain embodiments, one example is a snap, in which a vehicle icon (e.g., on a display) suddenly jumps to a new position instead of a smooth motion. In one embodiment, the first position value of step 206 is replaced with the received current position value of step 208.

A determination is made at step 214 as to whether the current heading received at 208 is different from the calculated first heading value of step 206. In one embodiment, this determination is made by the processor 136 of FIG. 1. In certain embodiments, this determination may comprise whether a difference between the received current heading of step 208 and the calculated first heading value of step 206 is greater than a predetermined threshold. In certain embodiments, one example is an icon representing a vehicle or its heading (e.g., on a display) suddenly changes its orientation (heading). In one embodiment, the first heading value of step 208 is replaced with the received current heading value of step 208). For example, without the process 200, the heading orientation of a particular vehicle may be compromised in certain situations, for example after the vehicle travels down several ramps of a parking structure. For example, in one embodiment, without the process 200, a vehicle system may compute the vehicle as heading South when the actual heading out of the garage is East, by way of example. However, with the process 200 (and the vehicle 100, including the position system 140, of FIG. 1) the position is corrected by the processor 136 of FIG. 1, and the heading is set to the correct setting by the processor 136 of FIG. 1. In addition, if the GNSS services is not yet available, then in certain embodiments the vehicle 100 can now utilize dead reckoning techniques with while using the correct position as the starting point, until a GNSS heading can be computed.

If it is determined that the current heading received at step 208 is not different from the calculated first heading value of step 206, then in one embodiment the process 200 terminates at step 224. In one embodiment, as the process 200 terminates following step 214, the vehicle 100 continues to use the first heading value from step 206, but also uses the substituted position value of step 212, (and, in certain embodiments, as further updated using dead-reckoning techniques, for example using the vehicle data of step 204 and the mapping database 132 of FIG. 1) for continued operation of the vehicle 100.

Conversely, if it is determined that the current heading received at step 208 is different from the calculated first position value of step 206, then in one embodiment at step 216 the vehicle heading is set equal to the received heading value of step 206. In one embodiment, this is performed via the processor 136 of FIG. 1, and the received current heading value is stored in the memory 138 of FIG. 1.

A determination is made at step 218 as to whether there are any other parameters in the received data. In one embodiment, this determination is made by the processor 136 of FIG. 1. In certain embodiments, the additional parameters may include information as to other specification indications pertaining to a current position and/or heading of the vehicle 100 (e.g., as to exactly where within a parking garage, tunnel, and/or other infrastructure element 102 the vehicle 100 is location and/or is travelling, and so on).

If it is determined that there are no other parameters in the received data, then in one embodiment the process 200 terminates at step 224. In one embodiment, as the process 200 terminates following step 218, the vehicle 100 continues to use the substituted position value of step 212 and the substituted heading value of step 216, (and, in certain embodiments, as further updated using dead-reckoning techniques, for example using the vehicle data of step 204 and the mapping database 132 of FIG. 1) for continued operation of the vehicle 100.

Conversely, if it is determined that there are no other parameters in the received data, then in step 220 in various embodiments one or more vehicle parameters are set equal to the received values from the infrastructure to vehicle communications of step 208. For example, in certain embodiments, vehicles parameters may be updated to indicate exactly where within a parking garage, tunnel, and/or other infrastructure element 102 the vehicle 100 is location and/or is travelling, and so on).

In one embodiment, following step 220, the process 200 terminates at step 224. In one embodiment, as the process 200 terminates following step 220, the vehicle 100 continues to use the substituted position value of step 212, the substituted heading value of step 216, and the substituted (or new) parameter values of step 220 (and, in certain embodiments, as further updated using dead-reckoning techniques, for example using the vehicle data of step 204 and the mapping database 132 of FIG. 1) for continued operation of the vehicle 100.

As noted above, FIGS. 3 and 4 which provide illustrations of exemplary infrastructure elements that can be utilized in connection with the process 200, in accordance with exemplary embodiments.

First, FIG. 3 provides an illustration in which the infrastructure element comprises a tunnel 300, in accordance with an exemplary embodiment. As shown in FIG. 3, the exemplary tunnel 300 of FIG. 3 includes three lanes, namely, a first lane 302, a second lane 304, and a third lane 306. In various embodiments, the transmitter(s) of the tunnel 300 provide separate first, second, and third signals 308, 310, and 312, corresponding to the respective lane 302, 304, or 306 in which the vehicle 100 is travelling. Accordingly, in various embodiments, the vehicle 100 will receive specific information as to the specific lane of the tunnel 300, along with a heading indicating the direction of travel of the vehicle 100 as it is travelling through the tunnel 300.

By way of example, in one embodiment the tunnel 300 comprises a tunnel having not just multiple lanes, but specifically different tubes, with each tube having at least one lane (such as the Lincoln Park Tunnel is New York, which has three different tubes, two lanes in each tube, but different end points between the end and center tubes. In certain embodiments (e.g., in the case of the Lincoln Park Tunnel) the tubes may have different exit points (e.g., if a vehicle 100 is in one tube then the vehicle 100 will exit the tunnel 300 in a South direction; and if the vehicle 100 is in another tube then the vehicle 100 will exist the tunnel 300 in a North direction, or the like). It will be appreciated that the number of lanes, tubes, and/or exits may vary in different embodiments. In either case, the information provided from the tunnel 300 to the vehicle 100 is utilized by the vehicle 100 for determining the current position and heading for the vehicle 100, among possible other parameters for the vehicle 100.

Next, FIG. 4 provides an illustration in which the infrastructure element comprises a parking garage 400, in accordance with another exemplary embodiment. As shown in FIG. 4, the exemplary parking garage 400 of FIG. 4 includes multiple lanes, including an entry lane 402 and an exit lane 404. In various embodiments, the transmitter(s) of the parking garage 400 provide separate respective signals 406, 408 for the entry lane 402 and the exit lane 404, respectively, corresponding to the respective lane 402, 404 in which the vehicle 100 is travelling. Accordingly, in various embodiments, the vehicle 100 will receive specific information as to the specific lane of the parking garage 400, along with a heading indicating the direction of travel of the vehicle 100 as it is travelling through the parking garage 400.

In certain embodiments, different lanes and/or locations of the parking garage 400 may lead to respective exits that are in different directions. For example, similar to the earlier discussion, without the process 200, the heading orientation of a particular vehicle may be compromised in certain situations, for example after the vehicle travels down several ramps of a parking structure. For example, in one embodiment, without the process 200, a vehicle system may compute the vehicle as heading South when the actual heading out of the garage is East, by way of example. However, in accordance with the process 200 and the vehicle 100 (including the position system 140 thereof) of the present Application, when this occurs, then in various embodiments the position of the vehicle 100 is corrected by the processor 136 of FIG. 1, and the heading of the vehicle 100 is set to the correct setting by the processor 136. In addition, if the GNSS services is not yet available, then the vehicle can utilize dead reckoning techniques using the correct position value as a starting point, in certain embodiments. In any case, the information provided from the parking garage 400 to the vehicle 100 is utilized by the vehicle 100 for determining the current position and heading for the vehicle 100, among possible other parameters for the vehicle 100.

Accordingly, methods, systems, and vehicles are provided for determining a position of a vehicle. In various embodiments, electronic messages are received from infrastructure elements in proximity to the vehicle, with the electronic messages including information as to a current position and a current heading of the vehicle, among other possible parameters. Also in various embodiments, a processor of the vehicle determines a position of the vehicle, and in certain embodiments also a heading of the vehicle and other parameters of the vehicle, using the information obtained in the electronic messages from the infrastructure element.

It will be appreciated that the systems, vehicles, and methods may vary from those depicted in the Figures and described herein. For example, the vehicle 100, the position system 140, and/or various components thereof may vary from that depicted in FIGS. 1-4 and described in connection therewith, in various embodiments. It will similarly be appreciated that the steps of the process 200 may differ from those depicted in FIGS. 2-4, and/or that various steps of the process 200 may occur concurrently and/or in a different order than that depicted in FIGS. 2-4, in various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining, via a receiver onboard a vehicle, location information from a infrastructure element in proximity to the vehicle; and
determining, via a processor onboard the vehicle, a position of the vehicle using the location information from the infrastructure element.

2. The method of claim 1, further comprising:
obtaining, via the receiver onboard the vehicle, heading information from the infrastructure element in proximity to the vehicle; and
determining, via the processor onboard the vehicle, a heading of the vehicle using the heading information from the infrastructure element.

3. The method of claim 1, further comprising:
obtaining a first position value for the vehicle using a satellite based navigation system; and
updating the first position value using the position of the vehicle as determined using the location information from the infrastructure element.

4. The method of claim 1, further comprising:
replacing the first position value with the position of the vehicle as determined using the location information from the infrastructure element, when the satellite based navigation system is unavailable.

5. The method of claim 1, wherein:
the step of obtaining the location information comprises, obtaining, via the receiver onboard the vehicle, location information from the infrastructure element in proximity to the vehicle, from a transmitter of the infrastructure element via a message transmitted from the infrastructure element to the vehicle via a short-range wireless connection, wherein the infrastructure element comprises an infrastructure element of a roadway on which the vehicle is travelling; and
the step of determining the position of the vehicle comprises determining, via the processor onboard the vehicle, the position of the vehicle using the location information from the infrastructure element of the roadway on which the vehicle is travelling.

6. The method of claim 1, wherein:
the step of obtaining the location information comprises, obtaining, via the receiver onboard the vehicle, location information from the infrastructure element in proximity to the vehicle, from a transmitter of the infrastructure element via a message transmitted from the infrastructure element to the vehicle via a short-range wireless connection, wherein the infrastructure element comprises a tunnel of a roadway on which the vehicle is travelling; and
the step of determining the position of the vehicle comprises determining, via the processor onboard the vehicle, the position of the vehicle using the location information from the tunnel of the roadway on which the vehicle is travelling.

7. The method of claim 1, wherein:
the step of obtaining the location information comprises, obtaining, via the receiver onboard the vehicle, location information from the infrastructure element in proximity to the vehicle, from a transmitter of the infrastructure element via a message transmitted from the infrastructure element to the vehicle via a short-range wireless connection, wherein the infrastructure element comprises a parking garage in which the vehicle is travelling; and
the step of determining the position of the vehicle comprises determining, via the processor onboard the vehicle, the position of the vehicle using the location information from the parking garage in which the vehicle is travelling.

8. A system comprising:
a receiver configured to be installed onboard a vehicle and to receive location information from a infrastructure element in proximity to the vehicle; and
a processor configured to be installed onboard the vehicle and to determine a position of the vehicle using the location information from the infrastructure element.

9. The system of claim 8, wherein:
the receiver is configured to obtain heading information from the infrastructure element in proximity to the vehicle; and
the processor is configured to determine a heading of the vehicle using the heading information from the infrastructure element.

10. The system of claim 8, wherein the processor is further configured to:
obtain a first position value for the vehicle using a satellite based navigation system; and
update the first position value using the position of the vehicle as determined using the location information from the infrastructure element.

11. The system of claim 8, wherein:
the receiver is configured to obtain the location information from a transmitter of the infrastructure element via a message transmitted from the infrastructure element to the vehicle via a short-range wireless connection, wherein the infrastructure element comprises an infrastructure element of a roadway on which the vehicle is travelling; and
the processor is configured to determine the position of the vehicle using the location information from the infrastructure element of the roadway on which the vehicle is travelling.

12. The system of claim 8, wherein:
the receiver is configured to obtain the location information from a transmitter of the infrastructure element via a message transmitted from the infrastructure element to the vehicle via a short-range wireless connection, wherein the infrastructure element comprises a tunnel of a roadway on which the vehicle is travelling; and
the processor is configured to determine the position of the vehicle using the location information from the tunnel of the roadway on which the vehicle is travelling.

13. The system of claim 8, wherein:
the receiver is configured to obtain the location information from a transmitter of the infrastructure element via a message transmitted from the infrastructure element to the vehicle via a short-range wireless connection, wherein the infrastructure element comprises a parking garage in which the vehicle is travelling; and
the processor is configured to determine the position of the vehicle using the location information from the parking garage in which the vehicle is travelling.

14. A vehicle comprising:
one or more wheels;
a drive system configured to power the one or more wheels;
a receiver installed onboard the vehicle, the receiver configured to receive location information from a infrastructure element in proximity to the vehicle; and
a processor installed onboard the vehicle, the processor configured to determine a position of the vehicle using the location information from the infrastructure element.

15. The vehicle of claim 14, wherein:
the receiver is configured to obtain heading information from the infrastructure element in proximity to the vehicle; and
the processor is configured to determine a heading of the vehicle using the heading information from the infrastructure element.

16. The vehicle of claim 14, wherein the processor is further configured to:
obtain a first position value for the vehicle using a satellite based navigation system; and
update the first position value using the position of the vehicle as determined using the location information from the infrastructure element.

17. The vehicle of claim 14, wherein the processor is configured to replace the first position value with the position of the vehicle as determined using the location information from the infrastructure element, when the satellite based navigation system is unavailable.

18. The vehicle of claim 14, wherein:
the receiver is configured to obtain the location information from a transmitter of the infrastructure element via a message transmitted from the infrastructure element to the vehicle via a short-range wireless connection, wherein the infrastructure element comprises an infrastructure element of a roadway on which the vehicle is travelling; and
the processor is configured to determine the position of the vehicle using the location information from the infrastructure element of the roadway on which the vehicle is travelling.

19. The vehicle of claim 14, wherein:
the receiver is configured to obtain the location information from a transmitter of the infrastructure element via a message transmitted from the infrastructure element to the vehicle via a short-range wireless connection, wherein the infrastructure element comprises a tunnel of a roadway on which the vehicle is travelling; and
the processor is configured to determine the position of the vehicle using the location information from the tunnel of the roadway on which the vehicle is travelling.

20. The vehicle of claim 14, wherein:
the receiver is configured to obtain the location information from a transmitter of the infrastructure element via a message transmitted from the infrastructure element to the vehicle via a short-range wireless connection, wherein the infrastructure element comprises a parking garage in which the vehicle is travelling; and
the processor is configured to determine the position of the vehicle using the location information from the parking garage in which the vehicle is travelling.
